(19) United States
(12) Patent Application Publication
(10) Pub. No.: US 2013/0209631 A1
(43) Pub. Date: Aug. 15, 2013

(54) Reversible baking pan

(71) Applicants: Tracy M. Connell, Shelby Township, MI (US); James R. Connell, Shelby Township, MI (US)

(72) Inventors: Tracy M. Connell, Shelby Township, MI (US); James R. Connell, Shelby Township, MI (US)

(21) Appl. No.: 13/369,785

(22) Filed: Feb. 9, 2012

(51) Int. Cl. A23G 3/20; A23G 3/54; B65D 79/00

(52) U.S. Cl. 426/282; 206/216

(57) ABSTRACT

A reversible baking pan 10 and method of using. The reversible baking pan 10 may have a first platform member 20 and a cup member 40. The first platform member 20 may have one or more openings 30. The cup members 40 may be located at the openings 30 and may comprise a wall 50 and a second platform member 60. The second platform member 60 may have an aperture 70 therethrough. In one orientation, the reversible baking pan 10 may be used to prepare confections including muffins and cupcakes; in another orientation, the reversible baking pan 10 may be used to prepare confections including cupcake cones and pudding cones. The reversible baking pan 10 may further be used to display the confections.

### TECHNICAL FIELD

The present invention relates to baking pans and more particularly to a pan for preparing baked goods.

### BACKGROUND

Muffins and cupcakes have been enjoyed by Americans for decades, and they may be found in a variety of sizes and flavors. Muffin pans are used by bakers at home and within commercial establishments to produce these bakery items.

Pudding cones and cupcake cones are relatively newer to the American diet than muffins and cupcakes. Both pudding and cupcake cones may utilize a commercially available cone. A pudding cone may be ready to eat after the cone is filled with a prepared pudding mixture or after the pudding mixture further solidifies in the cone (e.g., when it is chilled for a period of time). A cupcake cone may be eaten after the cone is filled with batter and baked for a period of time.

### SUMMARY

According to an embodiment of the invention, there is provided a reversible baking pan having: a first platform member having one or more openings therethrough; and one or more cup members coupled to the first platform member, wherein a respective cup member may have a wall circumscribing a respective opening and forming a cavity, wherein the wall is coupled to and extends away from the first platform member; and a second platform member spaced from the first platform member, coupled to the wall, and having an aperture therethrough, wherein at least a portion of the second platform member extends radially inwardly within the wall.

According to another embodiment of the invention, there is provided a method of preparing confections in a reversible baking pan. The steps may comprise: locating a confection container at a cup member of the reversible baking pan, wherein the reversible baking pan has: a first platform member having one or more openings therethrough; and one or more cup members coupled to the first platform member, wherein a respective cup member may have a wall circumscribing a respective opening and forming a cavity, wherein the wall is coupled to and extends away from the first platform member; and a second platform member spaced from the first platform member, coupled to the wall, and having an aperture therethrough, wherein at least a portion of the second platform member extends radially inwardly within the wall; and placing a confection within the confection container.

According to another embodiment of the invention, there is provided a reversible baking pan for use in a non-microwave oven. The reversible baking pan may have: a first platform member having one or more openings therethrough; and one or more cup members coupled to the first platform member wherein a respective cup member may have: a wall circumscribing a respective opening and forming a cavity, wherein the wall is coupled to and extends away from the first platform member; and a second platform member having an aperture therethrough, spaced from the first platform member, wherein the second platform member is coupled to and circumscribed by the wall.

### BRIEF DESCRIPTION OF THE DRAWINGS

One or more embodiments of the invention will hereinafter be described in conjunction with the appended drawings, wherein like designations denote like elements, and wherein:

FIG. 1 is a perspective view of an exemplary embodiment of a reversible baking pan in a first position carrying an exemplary ice cream cone and carrying an exemplary cupcake cone;

FIG. 2 is another perspective view of the exemplary embodiment of the reversible baking pan in a reversed position carrying an exemplary baking cup and carrying an exemplary cupcake;

FIG. 3 is a bottom plan view of the exemplary embodiment of the reversible baking pan;

FIG. 4 is a partial cross-sectional view of the reversible baking pan shown in FIG. 3 along section lines 4-4; and

FIG. 5 is a partial cross-sectional view of an alternative embodiment of the reversible baking pan shown in FIG. 3 along section lines 4-4.

### DETAILED DESCRIPTION OF THE ILLUSTRATED EMBODIMENTS

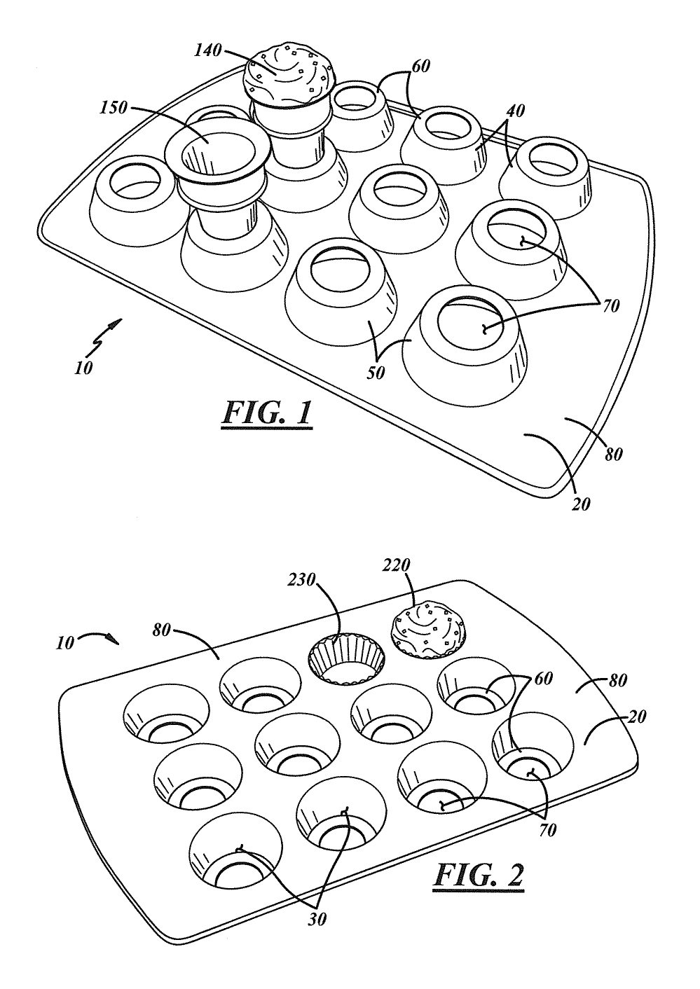

The following disclosure describes a reversible baking pan that may be used for preparing confections using confection containers (including carrying, baking, displaying or any combination thereof) and a method of using the baking pan. Confections as used herein may include cake or cake batter, bread (e.g., a muffin) or bread batter, pastry batter or pastries, puddings, dessert fillings (e.g., pie filling, whipped cream, etc.), and gelatinous foods, desserts, or other material. Confection containers may or may not be edible and may include ice cream cones and baking cups. The reversible baking pan 10 may have a first platform member 20 with a plurality of openings or holes 30. One or more cup members 40 may be located at the openings 30. A respective cup member 40 may include a wall 50 and a second platform member 60. The respective second platform member 60 may be spaced from the first platform member 20 with the respective wall therebetween, the respective wall 50 being coupled at one end to the first platform member 20 and being coupled at the opposing end to the second platform member 60. The respective second platform member 60 may have an aperture 70 therethrough. When the reversible baking pan 10 is positioned or located such that the second platform member 60 is below the first platform member 20 (FIG. 2), the baking pan 10 may be used to prepare confections using baking cups (e.g., muffins, cupcakes, etc.). And when the reversible baking pan 10 is positioned or located such that the second platform member 60 is above the first platform member 20 (FIG. 1), the baking pan 10 may be used to prepare confections using ice cream cones (e.g., cupcake cones, pudding cones, etc.). A more detailed description of the reversible baking pan 10 will be provided hereafter.

According to one embodiment, the baking pan 10 may comprise the first platform member 20 and a plurality of cup members 40. The first platform member 20 may be generally planar, and as shown, it may be generally rectangular in shape. For example, the corners of the first platform member 20 may or may not be square—e.g., they may be chamfered or rounded. And the outer perimeter of the first platform member 20 may have an open or closed hemmed edge. The first platform member 20 may have a lip region 80 extending outwardly away from the plurality of openings 30. On two of the opposing ends of the first platform member 20, the lip region 80 may extend farther away from the openings 30 than on the other two remaining ends and may provide a place in which to grasp the baking pan 10 more securely. In some embodiments, the larger lip regions 80 may further have grips to facilitate moving the baking pan 10, particularly when it is hot. In addition, the first platform member 20 may have other functional and/or ornamental features and contours.

The first platform member 20 may have one or more openings 30 therethrough, and the openings 30, as illustrated, may be circular. The diameter of the openings 30 may vary; for example in one embodiment, they may range from 2 to 5 inches. However, this range is not exclusive; smaller or larger diameters are possible also. The openings 30 shown in the illustrated embodiment are uniform and approximately 2.75 inches in diameter. As will be appreciated by one skilled in the art, the diameter of the openings 30 may be selected based upon the desired diameter of the confection (e.g., the diameter of a muffin). Where a plurality of openings 30 are present, as in the illustrated embodiment, the openings 30 may be arranged in columns and rows (e.g., 3×4). Further, the openings 30 may be evenly spaced from each other. In the illustrated embodiment, the openings 30 are approximately 3.5 inches on center, leaving spacing of approximately 0.5 inch between the openings 30. In other embodiments, the amount of spacing between the openings 30 may be dependent upon the opening 30 diameter; e.g., the spacing may be greater in instances where the diameters of the openings are 5 inches rather than when the diameter of the openings are 2 inches. Those skilled in the art will appreciate that a larger opening 30 may accommodate a greater volume of batter; and that a greater volume of batter may experience greater expansion over the top of the respective opening 30 during heating than a lesser amount of batter. Hence, additional spacing may be beneficial when the openings 30 are larger. Similarly, when the openings 30 are smaller, the amount of spacing between the openings 30 may be less.

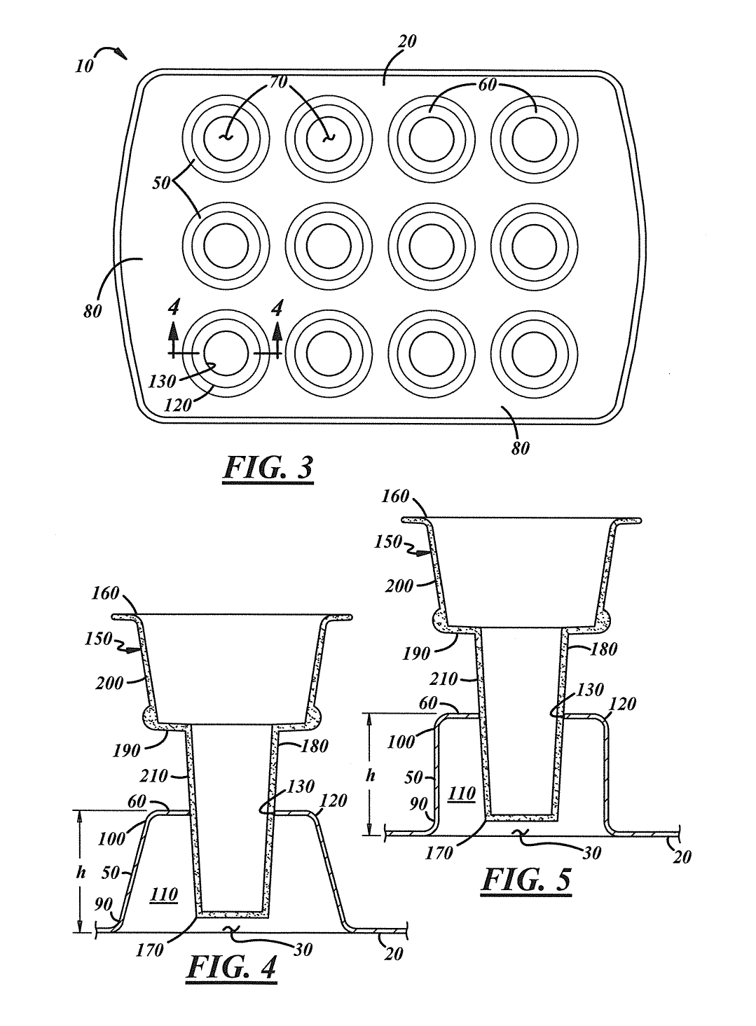

As shown in FIGS. 1-3, the cup members 40 may be located at all the openings 30 of the first platform member 20 (although this is not essential). The cup members 40 may comprise the wall 50 and the second platform member 60. The wall 50 may comprise a first end 90 and a second end 100 (opposite the first end) and circumscribe a cavity 110 located at the respective opening 30. The second platform member 60 may be generally annular in shape. The perimeter of the second platform member 60 may be defined by an outer edge 120. The aperture 70 in the second platform member 60 may be defined by an inner edge 130.

The first end 90 of the wall 50 may be coupled to the first platform member 20 and may extend away therefrom. The second end 100 of the wall 50 may be coupled to the respective second platform member 60. All or part of the entire first end 90 of the wall 50 may be coupled to the first platform member 20. And all or part of the second end 100 of the wall 50 may be coupled to the second platform member 60. The first platform member 20 may be spaced from the second platform member 60; this spacing is illustrated in FIGS. 4-5 as the height (h) of the wall 50. The wall 50 may or may not be perpendicular to the first platform member 20; similarly, the wall 50 may or may not be perpendicular to the second platform member 60. The wall 50 may be frustoconical—for example, the diameter of the cavity 110 at the opening 30 may be approximately 2.75 inches; and the diameter of the cavity near the second platform member 60 may be approximately 2.25 inches. Other shapes are also possible; e.g., the wall 50 may be cylindrical (FIG. 5) or have various functional or ornamental curves and angles. Where the baking pan 10 has a plurality of the cup members 40, the respective second platform members 60 of the cup members 40 may be parallel to and equally spaced from the first platform member 20. In the illustrated embodiment, the outer edge 120 of the second platform member 60 is defined by the second end 100 of the respective wall 50, being circumscribed therein. However, this is not essential—the outer edge 120 of the second platform member 60 may extend radially outwardly of the wall 50—having various shapes.

As previously described, the second platform member 60 may include the aperture 70. The aperture may be defined by the inner edge 130 of the second platform member 60. The aperture 70 may have various sizes or shapes. In the exemplary embodiment, the respective aperture 70 is circular and centered within the respective wall 50 on the second platform member 60. Thus, as in the illustrated example, the shape of the second platform member 60 may be annular, as defined by its inner and outer edges 120, 130. The size of the illustrated aperture 70 is approximately 1.25 inches.

Other sizes and shapes of the second platform member 60 are possible. For example, the shape of the aperture 70 may be a square, a triangle, a star, an oval, etc. The shape and size of the respective aperture 70 may depend upon the size of the confection containers to be used (e.g., larger confection containers may require a larger aperture 70). As will be appreciated by one skilled in the art, the sizes and shapes of the confection container (e.g., an ice cream cone 150 or a baking cup 230) can vary widely. The respective aperture 70, for example, may be sized to support the ice cream cone 150 when the baking pan 10 is positioned with the second platform member 60 above the first platform member 20 (e.g, the inner edge 130 of the second platform member 60 may support the side(s) 180 of the ice cream cone 150; FIGS. 4-5). In addition, the respective aperture 70, for example, may be sized such that the surface area of the second platform member 60 which is circumscribed within the wall 50 is sufficient to support the bottom of the baking cup 230 (see FIG. 2) when the baking pan 10 is positioned with the second platform member 60 below the first platform member 20—e.g., small enough to restrict the baking cup 230 from falling through the aperture 70 when the baking cup 230 contains a confection (e.g., batter).

The second platform member 60 may entirely support (or bear the entire weight of) the confection container and its contents. For example, where the confection is a muffin, cupcake 220 or the like, the base of the confection container (e.g., the baking cup 230) may be supported entirely within the cavity 110 by the second platform member 60. Baking cups 230 may be available in a variety of styles, shapes, and materials as well (and include but are not limited to foil, paper, silicone, and metal baking cups having sides which are smooth or scallop-pressed). In another example, the confection may be cake batter or the like, and the confection container (e.g., an ice cream cone 150) may be supported entirely by the inner edge 130 of the second platform member 60. Ice cream cones 150 may be available in a variety of styles, shapes, and materials (which include but are not limited to sugar cones, cake cones, wafer cones, waffle cones, and pretzel cones).

Due to the variances in size, shape, and material of confection containers, a wide variety of reversible baking pan 10 embodiments exist. For example, the baking pan 10 may be designed for large muffins (or cupcakes 220) and smaller ice cream cones 150 or vice-versa. In the first instance, for example, the respective opening 30 in the first platform member 20 may be relatively large (e.g., to accommodate the baking cup 230 with a larger diameter), and also the area of the respective second platform member 60 that is circumscribed within the respective wall 50 may also be large (e.g., to carry a baking cup 230 having a large base). However, the respective aperture 70 may be relatively small in comparison to the area of the second platform member 60 circumscribed by the wall 50 (e.g., to carry a smaller ice cream cone 150). In another example, the respective aperture 70 may be large in relation to the area of the respective second platform member 60 circumscribed by the wall 50. In this instance, the aperture 70 may be sized to carry a larger ice cream cone 150. Where the area of the respective second platform member 60 circumscribed by the wall 50 is minimized, stiffer baking cups 230 may be used to ensure the baking cup 230 does not fall through the aperture 70 (e.g., metal or foil baking cups). In all variations and embodiments, the second platform member 60 may entirely support the confection container (150, 230).

The overall size and dimensions of the reversible baking pan 10 may vary. In the illustrated embodiment of FIGS. 1-3, the baking pan 10 may be sized to fit within a residential baking oven; for example, the first platform member 20 may be approximately 12 inches by 16 inches, and the second platform members 60 may be spaced from the first platform member 20 by approximately 1.5 inches. However, in other embodiments, the baking pan 10 may be larger or smaller. For example, larger baking pans 10 may be manufactured for and used within commercial baking ovens having a larger first platform member 20 and a larger number of cup members 40 (e.g., the baking pans may be approximately 20 inches by 30 inches and have 45 cup members (e.g., 5 rows by 9 columns)). Of course, where the diameter of the openings 30 in the first platform member 20 is smaller, a larger quantity of cup members 40 is also possible per square foot of the first platform member 20.

Other embodiments of the reversible baking pan 10 are possible. For example, the shape of the openings 30 in the first platform member 20 may vary; e.g., a respective opening 30 may have various curves and/or angles. In addition, the openings 30 may be the same shape while the sizes may vary (e.g., the first platform member 20 may have circular openings 30 of varying sizes) or vice-versa. And the respective walls 50 may be curved or angled accordingly to enable the production of confections which are shaped the same (e.g., a star-shaped muffin). In addition, the height (h) of the wall 50 may vary.

In one embodiment, the reversible baking pan 10 may be made of a material that can withstand heating to temperatures of 500 degrees Fahrenheit; e.g., it may be made of metal, polymers (including silicones and plastics), and/or composite. The baking pan 10 may be manufactured in various ways; for example, it may be produced using a mold or by stamping. One method of manufacture may include punching one or more openings 30 in the first platform member 20 and then welding molded cup members 40 to the first platform member 20. The baking pan 10 may have a non-stick coating. In one embodiment, the baking pan 10 is made of metal or metal alloy; has at least one exterior layer of non-stick coating; and may be used in a gas, electric, or wood-fired oven. The coating may comprise polytetrafluoroethylene (PTFE). In other embodiments, the coating may include PTFE and an additional additive, such as a powdered ceramic or titanium (or both). Other coatings are possible. The coating may be applied in a liquid state and may comprise one or more layers. And the thicknesses of the layers may vary.

As mentioned above, the reversible baking pan 10 may be used to prepare cupcake cones 140. One exemplary method may include: orienting or positioning the baking pan 10 with the second platform member 60 located above the first platform member 20 (FIG. 1); placing or locating one or more ice cream cones 150 in the respective apertures 70 of the cup members 40; placing cake batter in the ice cream cones 150 (e.g., filling the cone approximately ¾ full—thus allowing for expansion during baking); heating the baking pan 10 and the confections for a predetermined period of time at a predetermined temperature; and separating the baking pan 10 and its contents from the heat.

In the method described above, when the one or more cones 150 are placed in the respective apertures 70, a respective cone 150 (which may have an open end 160 and a closed end 170) may be placed with the open end 160 extending away from the second platform member 60 (e.g., upwards) and the closed end 170 being placed through the respective aperture 70 towards the first platform member 20 (e.g., downwards). The cone 150 may be carried by the cup member 40 in various ways. For example, some ice cream cones 150 are conically-shaped or frustoconically-shaped—the cone 150 may be carried at its side 180 by the inner edge 130 of the second platform member 60 (FIGS. 4-5). Some ice cream cones 150 may also have a two-tiered shape (upper and lower tiers) with a lip 190 therebetween (FIGS. 4-5). The upper tier 200 and/or the lower tier 210 may or may not be conically or frustoconically shaped. In some cases, these cones 150 may be carried by resting the lip 190 of the cone 150 on second platform member 60 with the lower tier 210 extending towards the first platform member 20.

In some heating devices, the source of the heat or heating element may be located at or near the base of a chamber within the device. Thus, as the heating element emits heat, the heat naturally rises and warms the chamber. When the reversible baking pan 10 is used to heat cupcake cones 140, the cup members 40 may trap or capture some of this heat in the cup members 40 as the heat rises. Similarly, in heating devices having the heating element located elsewhere but using forced air, circulated heat may become captured in the cup members 40. During the heating step, the heat nearer to the top of the chamber may bake the confection (e.g., batter) near the top of the cone 150 (or near the upper tier 200) while the heat captured within the cup members 40 may bake the confection near the bottom of the cone 150 (or near the lower tier 210). Thus, the cup members 40 of the baking pan 10 may facilitate cooking the batter more evenly—preventing the top of the batter from cooking too quickly and leaving the lower batter less- or under-cooked.

The heating step may be performed using a variety of heating devices. For example, the heating device may be a thermally insulated chamber including but not limited to: earth ovens, ceramic ovens, masonry ovens, solar ovens, convection ovens, reflection ovens, microwave ovens, dutch ovens; and includes ovens heated by gas, electricity, or wood-firing and those used in residential, commercial, or industrial applications.

In another exemplary method, the reversible baking pan 10 may be used to prepare pudding cones. The method may include: orienting or positioning the baking pan 10 with the second platform member 60 located above the first platform member 20 (FIG. 1); placing or locating one or more ice cream cones 150 in the respective apertures 70 of the cup members 40; and placing pudding in the ice cream cones 150 (e.g., at least partially filling the cone).

Both the cupcake cones 140 and the pudding cones may be then further be displayed in the reversible baking pan 10; i.e., using the baking pan 10 as a stand to hold and/or serve the confections.

In another exemplary method, the reversible baking pan 10 may be used to prepare cupcakes 220 (or muffins). This method may include: orienting or positioning the baking pan 10 with the second platform member 60 located below the first platform member 20 (FIG. 2); placing or locating one or more baking cups 230 in the cup members 40 so that the base of the respective baking cup 230 is carried by the second platform member 60; placing cake batter in the baking cups 230 (e.g., filling the baking cups approximately ¾ full—thus allowing for expansion during baking); heating the baking pan 10 and the confections for a predetermined period of time at a predetermined temperature; and separating the baking pan 10 and its contents from the heat. The heating step may be performed using a variety of heating devices. For example, the heating device may be a thermally insulated chamber including but not limited to: earth ovens, ceramic ovens, masonry ovens, solar ovens, convection ovens, reflection ovens, microwave ovens, dutch ovens; and includes ovens heated by gas, electricity, or wood-firing and those used in residential, commercial, or industrial applications.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A reversible baking pan, comprising:
a first platform member having one or more openings therethrough; and
one or more cup members coupled to the first platform member wherein a respective cup member comprises:
a wall circumscribing a respective opening and forming a cavity, wherein the wall is coupled to and extends away from the first platform member; and
a second platform member spaced from the first platform member, coupled to the wall, and having an aperture therethrough, wherein at least a portion of the second platform member extends radially inwardly within the wall.

2. The reversible baking pan as defined in claim 1 wherein the wall is frustoconical.

3. The reversible baking pan as defined in claim 1 wherein the wall is cylindrical.

4. The reversible baking pan as defined in claim 1 wherein the aperture, when the second platform member is positioned above the first platform member, is sized to support an ice cream cone with the ice cream cone having an open end extending away from the second platform member and having a closed end being located inside of the cavity and towards the first platform member.

5. The reversible baking pan as defined in claim 1 wherein the portion of the second platform member that extends radially inwardly, when the first platform member is positioned above the second platform member, is sized to support a baking cup.

6. The reversible baking pan as defined in claim 1 further comprising a non-stick coating on the exterior of the baking pan.

7. The reversible baking pan as defined in claim 1 wherein the second platform member is circumscribed by the wall.

8. The reversible baking pan as defined in claim 7 wherein the second platform member is annular.

9. The reversible baking pan as defined in claim 1 wherein the reversible baking pan may be made of material that includes: one or more metals, one or more polymers, one or more silicones, one or more plastics, or one or more composites.

10. A method of preparing confections in a reversible baking pan, the steps comprising:
locating a confection container at a cup member of the reversible baking pan, wherein the reversible baking pan comprises:
a first platform member having one or more openings therethrough; and
one or more cup members coupled to the first platform member wherein a respective cup member comprises:
a wall circumscribing a respective opening and forming a cavity, wherein the wall is coupled to and extends away from the first platform member; and
a second platform member spaced from the first platform member, coupled to the wall, and having an aperture therethrough, wherein at least a portion of the second platform member extends radially inwardly within the wall; and
placing a confection within the confection container.

11. The method as defined in claim 10 further comprising positioning the reversible baking pan with the second platform member located above the first platform member.

12. The method as defined in claim 11 wherein the locating step further comprises locating through the aperture the ice cream cone having an open end extending away from the second platform member and having a closed end extending towards the first platform member.

13. The method as defined in claim 12 further comprising the step of heating the confection.

14. The method as defined in claim 12 further comprising the step of displaying the confection in the reversible baking pan.

15. The method as defined in claim 10 further comprising the steps of positioning the reversible baking pan with the second platform member located below the first platform member, and locating a baking cup on the portion of the second platform member that extends radially inwardly within the wall.

16. The method as defined in claim 15 further comprising the step of heating the confection in the reversible baking pan.

17. The method as defined in claim 15 further comprising the step of displaying the confection in the reversible baking pan.

18. The method as defined in claim 10 wherein the confection includes: cake batter, bread batter, pastry batter, pudding, dessert filling, and gelatinous food.

19. A reversible baking pan for use in a non-microwave oven, comprising:
a first platform member having one or more openings therethrough; and
one or more cup members coupled to the first platform member wherein a respective cup member comprises:
a wall circumscribing a respective opening and forming a cavity, wherein the wall is coupled to and extends away from the first platform member; and
a second platform member having an aperture therethrough, spaced from the first platform member, wherein the second platform member is coupled to and circumscribed by the wall.

20. The reversible baking pan as defined in claim 19 wherein the aperture, when the second platform member is positioned above the first platform member, is sized to support an ice cream cone having an open end extending away from the second platform member and having a closed end being located inside of the cavity and towards the first platform member, and wherein the second platform member, when the first platform member is positioned above the second platform member, is sized to support a baking cup.
